(19) United States
(12) Patent Application Publication
(10) Pub. No.: US 2007/0137583 A1
(43) Pub. Date: Jun. 21, 2007

(54) Pet bed

(76) Inventor: Mark Warwick Angus, Wellington (NZ)

Correspondence Address: WEISS & MOY PC, 4204 NORTH BROWN AVENUE, SCOTTSDALE, AZ, 85251, US

(21) Appl. No.: 11/305,678

(22) Filed: Dec. 16, 2005

(51) Int. Cl. A01K 29/00

(52) U.S. Cl. 119/28.5

(57) ABSTRACT

A pet bed having a base 1, a removable cushion 3 of sufficient dimensions to fit substantially snugly within the base, a wall 2 looping around the base 1 to the extent that when the cushion 3 is fitted within the base 1 the wall provides an upstanding boundary substantially around the cushion 3. The cushion has an opening which enables access to inner parts of the cushion. The bed has heating means 4 able to safely and substantially heat the cushion and/or having magnetic therapy means 4 able to apply magnetic therapy to an animal when laying on the cushion.

### FIELD OF THE INVENTION

This invention relates to a pet bed.

### BACKGROUND

It is known to keep pets in a domestic situation and it is desirable to provide a comfortable place for such an animal to rest. It is accordingly an object of at least one embodiment of the present invention to go at least some way towards achieving this.

The term “comprising” or derivatives thereof, if and when used herein, should be interpreted non-exclusively—eg to convey “consisting of or including”.

### SUMMARY OF THE INVENTION

According to one aspect of the invention there is provided a portable pet bed having a base portion, a removable cushion of sufficient dimensions to fit substantially snugly within the base portion, a wall portion extending around a substantial part of the base portion to the extent that when the cushion is fitted within the base portion the wall portion provides an upstanding boundary substantially around the cushion, the cushion having an opening which enables access to inner parts of the cushion, the bed having heating means able to safely and substantially heat the cushion and/or having magnetic therapy means able to apply magnetic therapy to an animal when laying on the cushion.

Optionally at least the cushion and the wall portion have leather lining.

Optionally the wall portion loops around the periphery of the base portion.

Optionally the heating means and/or the magnetic therapy means is/are substantially within the cushion.

Optionally both of the heating means and the magnetic therapy means are present.

Optionally the heating means and the magnetic therapy means are contained as parts of a unitary device.

Optionally the heating means comprises a heating pad.

Optionally the magnetic therapy means is in the form of a pad. In some embodiments of the invention the magnetic therapy means comprises a magnetic material dispersed throughout pad material.

Optionally the pet bed is formed so that it is able to be substantially and significantly compacted and wherein on relaxation of the compacting force the bed automatically reverts to its original form due to its substantially resilient characteristics

### DESCRIPTION OF THE DRAWING

Some preferred forms of the invention will now be described by way of example and with reference to the accompanying drawings, of which:

FIG. 1 is a plan view of a portable pet bed,

FIG. 2 is a transverse cross section view taken through line A-A of FIG. 1,

FIG. 3 is a perspective view of the pet bed of FIGS. 1 and 2,

FIG. 4 is a plan view of a further portable pet bed, and

FIG. 5 is a transverse cross section view taken through line B-B of FIG. 4.

### DETAILED DESCRIPTION

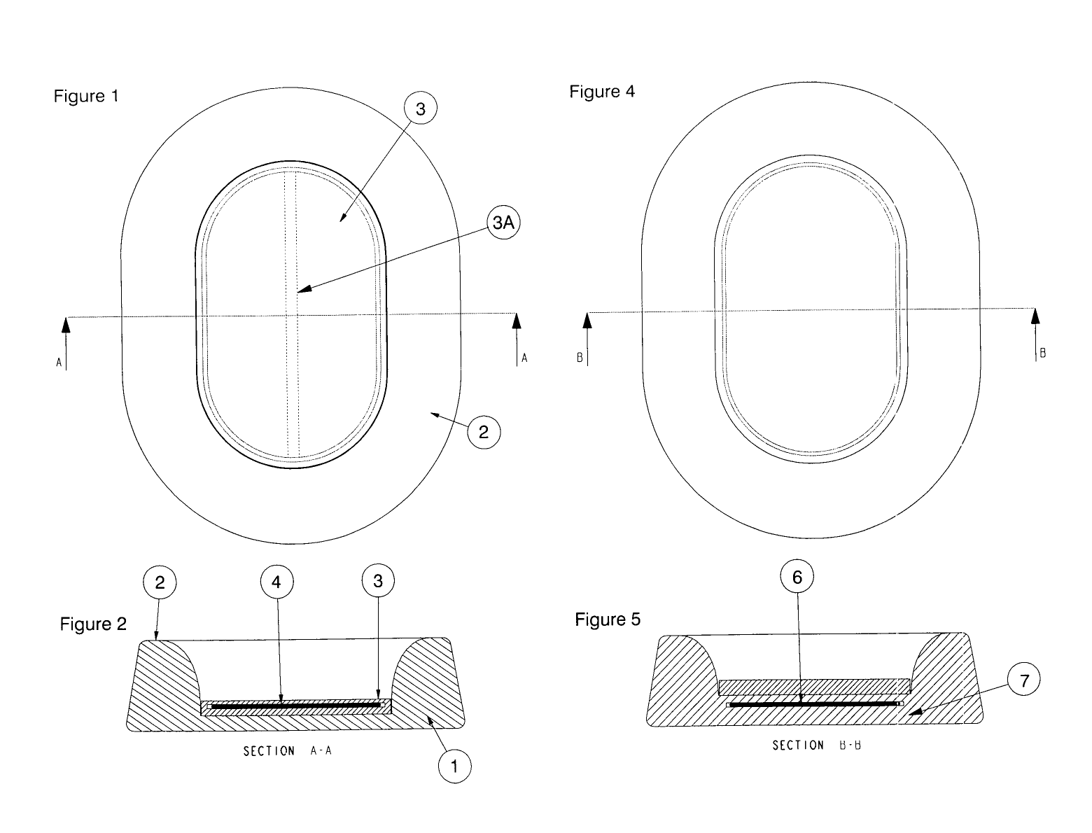

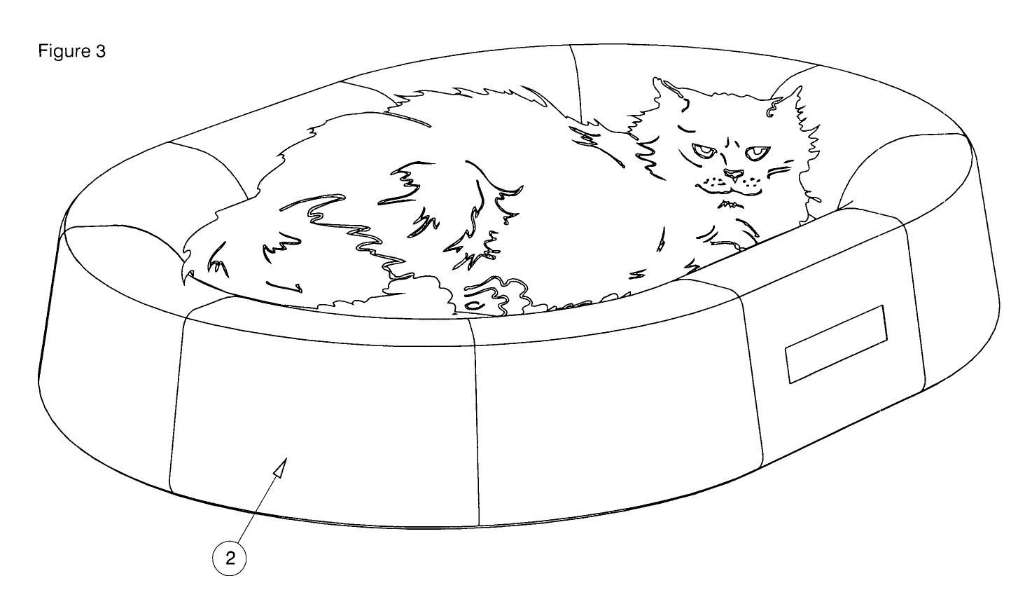

Referring to FIGS. 1 and 2, a preferred form of the invention is a portable pet bed having a base 1, a wall 2 extending around the base, a removable cushion 3, and a heating and magnetic therapy pad 4 within the cushion. The wall 2 loops around the base 1 to provide a snug enclosure for a cat or dog. The dimensions of the cushion 3 are such that when it is on the base 1 and within the wall 2 it is significantly lower than the highest part of the wall. With reference to FIG. 3, when the bed is in use a pet such as a cat can lay on the cushion 3 in comfort completely surrounded by the wall 2. The wall 2 gives the cat a clearly defined territorial space, effectively hugging the cat, and may promote a feeling of security within the animal.

The cushion 3 can be easily gripped and lifted from the rest of the bed when desired so as to facilitate cleaning or the like. The underside of the cushion 2 has a slit-like opening 3A to enable ready access to the inside thereof (eg to a polyurethane foam inner). This allows one to remove and replace the cushion's internal padding when desired. The cushion 3 may be substituted when desired. For example the pet bed may have a number of interchangeable cushions 3, each having a different degree of padding or lining (eg alternative skin types). In some embodiments of the invention the cushion may have a “fluffy” surface.

The heating and magnetic therapy pad 4 can be activated to enhance the comfort or well being of a pet laying on the cushion. The pad 4 is powered by a mains supply of electricity, or by battery, to comfortably warm the cushion when desired. The pad 4 also applies magnetic therapy to the pet and preferably this does not require a source of electricity or battery power. To enable this the pad 4 may include magnetic particles spread throughout it. In some embodiments of the invention there may be separate heating and magnetic therapy pads so that they can be used individually or together. The pet bed is preferably leather lined. It has been found that many pets prefer to lay on a leather surface than on certain synthetic materials. The use of leather gives some animals a particular affinity for the bed and also enables ready cleaning of its surfaces. The bottom 5 of the base may have a non-leather stippled surface for grip, and to protect against wear from the underlying floor surface (not shown).

In some embodiments of the invention the pet bed is formed so that it can be substantially compacted, for example for packing and storage, and will thereafter revert to its original form due to the flexibility and/or resilience of at least most of the materials from which it is formed. This is facilitated by the use of suitable types of known synthetic foam or similar in the manufacture of the bed. In this regard lined molded foam may be used for the base 1 and the wall 2.

FIGS. 4 and 5 show an alternative pet bed similar to that described above except that it does not have a heating and magnetic therapy pad within the cushion. Rather it has a heating and/or magnetic therapy pad 6 arranged permanently within the body of the base 7.

The magnetic therapy feature may, in some embodiments of the invention, be achieved by way of suitably rated and configured static magnetic material. Preferably heating of the cushion is achieved by way of a suitable electric heating wire, shielded so that it does not undesirably interfere with the magnetic therapy.

While some preferred forms of the invention have been described by way of example it should be appreciated that modifications and improvements can occur without departing from the scope of the following claims.

1. A portable pet bed having a base portion, a removable cushion of sufficient dimensions to fit substantially snugly within the base portion, a wall portion extending around a substantial part of the base portion to the extent that when the cushion is fitted within the base portion the wall portion provides an upstanding boundary substantially around the cushion, the cushion having an opening which enables access to inner parts of the cushion, the bed having heating means able to safely and substantially heat the cushion and magnetic therapy means able to apply magnetic therapy to an animal when laying on the cushion, the heating means and the magnetic therapy means powered by one of electricity or by battery.

2. A pet bed according to claim 1, wherein at least the cushion and the wall portion have leather lining.

3. A pet bed according to claim 1, wherein the wall portion loops around the periphery of the base portion.

4. A pet bed according to claim 1, wherein the wall portion loops around the periphery of the base portion and wherein the heating means and/or the magnetic therapy means is/are substantially within the cushion.

5. (canceled)

6. A pet bed according to claim 1, wherein the wall portion loops around the periphery of the base portion, the heating means and/or the magnetic therapy means is/are substantially within the cushion, and the heating means and the magnetic therapy means are contained as parts of a unitary device.

7. A pet bed according to claim 1, wherein the wall portion loops around the periphery of the base portion, the heating means and/or the magnetic therapy means is/are substantially within the cushion, and wherein the heating means comprises a heating pad.

8. A pet bed according to claim 1, wherein the wall portion loops around the periphery of the base portion, the heating means and/or the magnetic therapy means is/are substantially within the cushion, and wherein the heating means and/or the magnetic therapy means is/are in the form of a pad.

9. A pet bed according to claim 1, formed so that it is able to substantially and significantly compacted wherein on relaxation of the compacting force the bed automatically reverts to its original form due to substantially resilient characteristics of the bed.

10. (canceled)

11. A portable pet bed having a base portion, a removable cushion of sufficient dimensions to fit substantially snugly within the base portion, a wall portion extending around a substantial part of the base portion to the extent that when the cushion is fitted within the base portion the wall portion provides an upstanding boundary substantially around the cushion, the cushion having an opening which enables access to inner parts of the cushion, the bed having heating means able to safely and substantially heat the cushion and magnetic therapy means able to apply magnetic therapy to an animal when laying on the cushion.
